(19) United States
(12) Patent Application Publication
(10) Pub. No.: US 2007/0018622 A1
(43) Pub. Date: Jan. 25, 2007

(54) Flexible buck converter to generate an output voltage higher or lower than an input voltage

(75) Inventor: Jiwei Chen, Santa Clara, CA (US)

Correspondence Address: CARLTON FIELDS, PA, 1201 WEST PEACHTREE STREET, 3000 ONE ATLANTIC CENTER, ATLANTA, GA, 30309, US

(73) Assignee: 02Micro, Inc.

(21) Appl. No.: 11/177,965

(22) Filed: Jul. 8, 2005

(51) Int. Cl. G05F 1/00

(52) U.S. Cl. 323/282

(57) ABSTRACT

A flexible power converter for providing an output voltage higher or lower than an input voltage. The power converter includes a first switch, a second switch and a third switch, a switch controller, and an isolation circuit. The power converter is connected to a high voltage source and an input voltage source. The switches are turned on and turned off independently, such that a stable output voltage is achieved, wherein the output voltage can be higher or lower than the input voltage.

### FIELD OF THE INVENTION

The invention relates to power management circuit for electronic devices, and in particular, to DC-DC power converters with wide variation of input voltage.

### BACKGROUND OF THE INVENTION

In order to be easier to use, portable electronic devices need to be usable under different conditions. One of the requirements for the portable electronic devices is to operate with different power supplies, such as an AC adapter, a car adapter, USB power line, and various kinds of rechargeable and non-rechargeable batteries, such as nickel-cadmium, nickel-metal hydride, lithium-ion, and lithium-polymer batteries. The actual voltages delivered by these different power supplies may vary in a wide range. For example, the voltage delivered by a fully charged battery may differ greatly from the voltage delivered by the same battery when it is nearly empty.

On the other hand, most integrated circuits (IC) in the portable electronic devices can only operate normally within a much narrower voltage range. However, due to different types and statuses of the input source to the electronic device, the voltage delivered to some ICs may vary greatly, i.e., the required power supply voltage to some ICs may be higher than the portable electronic device's input voltage or lower than the portable electronic device's input voltage. Consequently, in order to provide a stable voltage for these ICs, power management circuits are used to generate such stable voltages. These power management circuits include low drop-out linear regulators, switched-capacitor regulators, switch mode DC-DC converters, etc. Among these circuits, switch mode DC-DC converters are most popular because of their high efficiency.

There are several traditional switch mode DC-DC converters which are capable of generating an output voltage higher or lower than an input voltage. For example, cascade buck-boost converter, H-bridge buck-boost converter, Single Ended Primary Inductance Converter (SEPIC), buck-boost converter, flyback converter, etc. Each of these converters has some drawbacks: cascade buck-boost and SEPIC buck-boost converters require more than one inductor for each channel, flyback converter requires a huge and expensive transformer, H-bridge buck-boost converter requires more switches. These traditional converters either require additional components or have a high cost. Furthermore, these converters have a relatively low power conversion efficiency compared with a single buck or boost converter. Therefore, it is to an improved buck converter that is capable of generating an output voltage higher or lower than an input voltage and at the same time having a low cost, fewer components and high efficiency the present invention is primarily directed.

### SUMMARY OF THE INVENTION

The present invention provides an enhanced buck converter structure. Compared with the traditional buck converter which can only realize step-down conversion function, the present invention is capable of generating an output voltage higher or lower than an input voltage with less cost, fewer components and better efficiency by adding only one additional switch to the traditional buck converter, and at any time, the conversion principle still obeys the traditional operation method.

In one embodiment of the invention, there is provided a power converter for providing an output voltage higher or lower than an input voltage. The power converter includes a first switch coupled between an input voltage and a node, a second switch coupled between a voltage source and the node, and a third switch coupled between the node and the ground, wherein the voltage of the voltage source is higher than the input voltage. When the input voltage is lower than the output voltage, the third switch is set to open and the first switch and second switch are alternately and mutually exclusively set to open and close. As a result, the converter generates the output voltage higher than the input voltage. When the input voltage is higher than the output voltage, the second switch is set to open and the first switch and third switch are alternately and mutually exclusively set to open and close. As a result, the converter generates the output voltage lower than the input voltage. The power converter further includes an isolation circuitry. The isolation circuitry includes an inductor and a capacitor. The inductor is coupled between the node and the output voltage, and the capacitor is coupled between the output voltage and the ground. The power converter further includes a switch controller to control the state of the first, second, and third switches according to the input information and output information collected by the switch controller.

In another embodiment of the invention, there is also provided a power converter for providing an output voltage higher than an input voltage. The power converter includes a voltage source, a first switch coupled between an input voltage and a node, a second switch coupled between a voltage source and the node, wherein the voltage of the voltage source is higher than the input voltage. The third switch is set to open and the first switch and second switch are alternately and mutually exclusively set to open and close. As a result, the converter is capable of generating the output voltage higher than the input voltage. The power converter further includes an isolation circuitry. The isolation circuitry includes an inductor and a capacitor. The inductor is coupled between the node and the output voltage, and the capacitor is coupled between the output voltage and the ground. The power converter further includes a switch controller to control the state of the first and second switches.

In yet another embodiment of the invention, there is also provided a method for generating an output voltage higher or lower than an input voltage. The method includes providing a first control signal to control a state of a first switch coupled between an input voltage and a node, providing a second control signal to control a state of a second switch coupled between the voltage source and the node, providing a third control signal to control a state of a third switch coupled between the node and the ground, opening the third switch, and alternately and mutually exclusively opening and closing the first switch and second switch when the input voltage is lower than the output voltage, and opening the second switch, and alternately and mutually exclusively opening and closing the first switch and third switch when the input voltage is higher than the output voltage. The voltage of the voltage source is higher than the input voltage.

In yet another embodiment of the invention, there is also provided a method for generating an output voltage higher than an input voltage. The method includes providing a first control signal to control a state of a first switch coupled between an input voltage and a node, providing a second control signal to control a state of a second switch coupled between the voltage source and the node, and alternately and mutually exclusively opening and closing the first switch and third switch. The voltage of the voltage source is higher than the input voltage.

### BRIEF DESCRIPTION OF THE DRAWINGS

Features and advantages of embodiments of the invention will become apparent as the following Detailed Description proceeds, and upon reference to the Drawings, where like numerals depict like elements, and in which:

FIG. 1 illustrates an exemplary topology of an improved buck converter according to the invention;

FIG. 2 illustrates a simplified equivalent circuit of FIG. 1 when an input voltage is higher than an output voltage;

FIG. 3 illustrates a simplified equivalent circuit of FIG. 1 when an input voltage is lower than an output voltage; and

FIG. 4 illustrates waveforms of few key electrical parameters when the input voltage is lower than the output voltage.

### DETAILED DESCRIPTION OF THE INVENTION

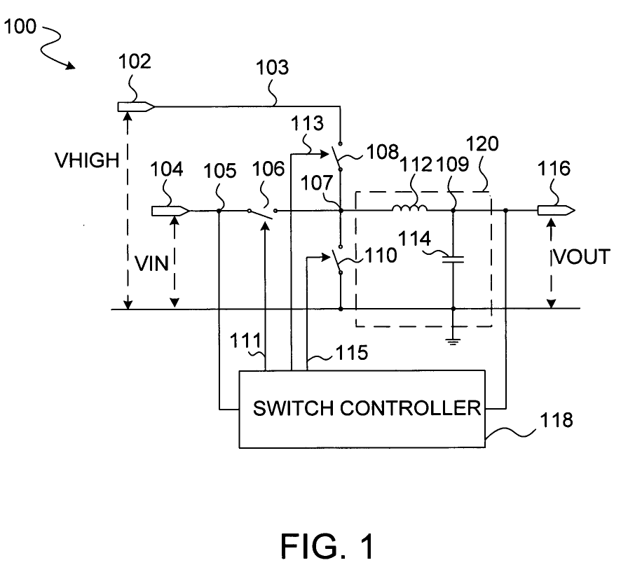

FIG. 1 illustrates an exemplary topology of an improved buck converter 100. In general, the improved buck converter 100 receives an input DC voltage, VIN, at an input port 104, and provides a desired output DC voltage, VOUT, at an output port 116. The output voltage may be higher or lower than the input voltage. The improved buck converter 100 includes a first switch 106, a second switch 108, a third switch 110, an isolation circuitry 120 and a switch controller 118. The switches used herein can be any type, for example, MOSFET (Metallic Oxide Semiconductor Field Effect Transistor), IGBT (Insulated Gate Bipolar Transistor), BJT (Bipolar Junction Transistor) and diode.

One terminal of the switch 106 is connected to the input port 104 via node 105, and its other terminal is connected to node 107. One terminal of switch 108 is connected to a port 102 via path 103, and its other terminal is connected to node 107. One terminal of switch 110 is connected to the ground and its other terminal is connected to node 107. The isolation circuitry 120 has an inductor 112 and a capacitor 114 connected to the inductor 112. The inductor 112 is coupled between node 107 and node 109, while the capacitor 114 is coupled between node 109 and the ground. Node 109 is connected to the output port 116. The isolation circuitry 120 is used for low-pass filtering of the voltage achieved at node 107 and thus obtaining the DC voltage, VOUT, at the output port 116. Additionally, the isolation circuitry 120 is also capable of isolating the input and output current, and preventing reversal of the output current, thereby keeping the continuity of the current.

The input voltage VIN is applied to the input port 104, while another voltage source VHIGH is applied to the port 102, and the output voltage VOUT is achieved at the output port 116. Generally, VHIGH is higher than the maximum possible voltage of VIN, and it may be delivered by any power source, which includes, but not limited to, a step-up converter, charging pump, AC adapter, etc. The step-up converter may include a switch mode boost DC-DC converter, a switch-capacitor converter, etc.

The converter 100 operates in two modes. When the input voltage VIN is lower than the output voltage VOUT, the converter 100 serves as a step-up converter. When the input voltage VIN is higher than the output voltage VOUT, the converter 100 serves as a step-down converter. The switch controller 118 decides in which mode to operate by checking the input information of the converter 100 via node 105 and output information via node 109. When the appropriate mode is set, the controller 118 generates three control signals on path 111, 113, and 115 to control the switches 106, 108, and 110 respectively, so that these switches can operate in that mode. Although in most cases the voltage information is collected, the current information of the input and the output may also be used for better performance.

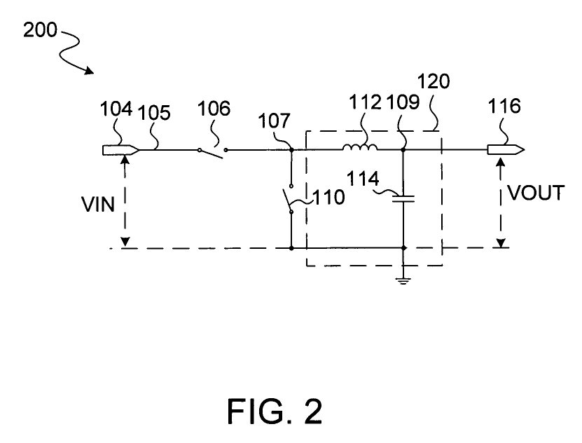

When the input voltage VIN is higher than the output voltage VOUT, the switch controller 118 sends a control signal via path 113 to turns off the switch 108, and the switches 106 and 110 are alternately and mutually exclusively set to open and close. FIG. 2 shows a simplified equivalent circuit 200 of FIG. 1 when the input voltage is higher than the output voltage. For clarity, the switch controller 118 is omitted herein. It is noted that FIG. 2 illustrates essentially a traditional buck converter. In one switch period T1, if the on time of the switch 106 is D1*T1, then the on time of the switch 110 should be (1−D1)*T1, wherein D1 is greater than zero and less than one, and the value of D1 is determined by the relationship between the input voltage level and the output voltage level. The relationship between VOUT and VIN is VOUT=D1*VIN. In this way, the input voltage is converted to a lower output voltage.

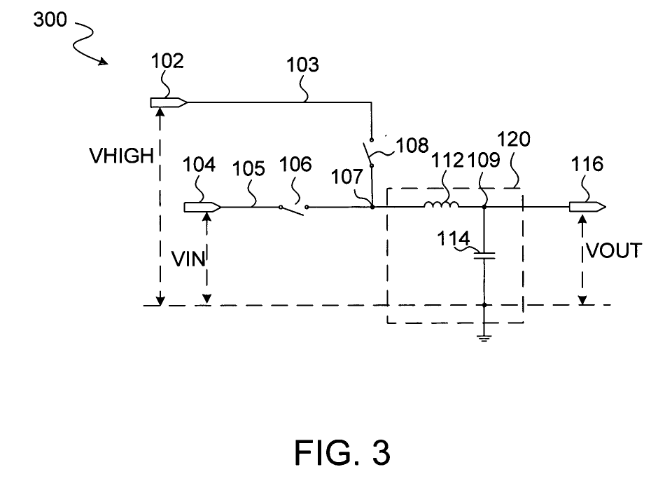

When the input voltage VIN is lower than the output voltage VOUT, the switch controller 118 sends a control signal via path 115 to turns off the switch 110, and the switches 106 and 108 are alternately and mutually exclusively set to open and close. FIG. 3 shows a simplified equivalent circuit 300 of FIG. 1 when the input voltage is lower than the output voltage. For clarity, the switch controller 118 is omitted herein. In one switch period T2, when the switch 108 is on, the voltage on node 107 equals the voltage at the port 102 VHIGH. When the switch 106 is on, the voltage at the node 107 equals the voltage at the input port 104 VIN. After the low-pass filtering of the isolation circuitry 120, VOUT is achieved at the output port 116 as the DC component of the voltage at the node 107. It is noted that at this time, the invention still works like a traditional buck converter, but with different input voltage levels.

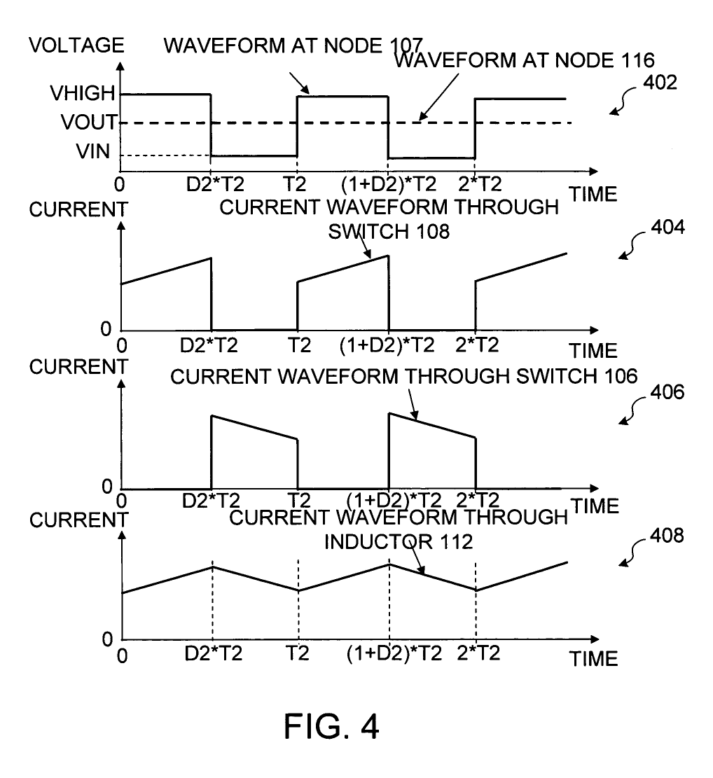

FIG. 4 illustrates waveforms of few key electrical parameters when the input voltage is lower than the output voltage. Plot 402 illustrates the voltage waveform at the node 107 and the voltage waveform at the output port 116. Plot 404 illustrates the current waveform through switch 108. Plot 406 illustrates the current waveform through the switch 106. Plot 408 illustrates the current waveform through the inductor 112. According to the plot 402, in one switch period T2, if the on-time of the switch 108 is D2*T2, then the on time of switch 106 should be (1−D2)*T1, wherein D2 is greater than zero and less than one, and the value of D2 is determined by the relationship between the input voltage level and the output voltage level. As such, VOUT can be derived as:
VOUT=D2*VHIGH+(1−D2)*VIN.

From this equation, it can be seen that VOUT is higher than VIN. It is also noted that when the switch 108 is on, VHIGH provides the required output current for VOUT. When the switch 106 is on, VIN provides the required output current for VOUT directly. That is, the power of VOUT is derived from a portion of VHIGH and a portion of original VIN. The topology of a traditional cascade buck-boost converter first uses a step-up converter to generate VHIGH from VIN, and then uses the traditional buck converter to generate VOUT from VHIGH. That is, the power of VOUT is obtained entirely from VHIGH, while VIGH is also converted from VIN. Therefore, the VOUT is derived through two complete conversion steps that decrease the conversion efficiency. Advantageously, compared with the conversion efficiency of the traditional cascade buck-boost converter, the topology of the present invention enjoys a higher efficiency.

Therefore, the current invention provides a flexible buck converter that delivers an output voltage higher or lower than an input voltage by utilizing only three switches to realize this functionality. Compared with a traditional DC-DC converter that provides the output voltage higher or lower than the input voltage, the current invention requires fewer components and has a high power conversion efficiency, and thereby, well extending the battery operating time when the input voltage is provided by the battery.

It is readily appreciated by those skilled in the art that the invention also provides an embodiment of a power converter capable of generating an output voltage higher than an input voltage, as illustrated in FIG. 3. Furthermore, the isolation circuitry 120 illustrated in the invention can be of any format as long as the circuit is capable of low-pass filtering or isolating the input and output current. It should also be noted that a circuit as shown in FIG. 1 but without the isolation circuitry 120, the remaining circuit in FIG. 1 can also be used as a converter and such circuit also embodies the spirit of the present invention.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A power converter for providing an output voltage higher or lower than an input voltage, the power converter comprising:
a node;
a first switch coupled between an input voltage and the node;
a second switch coupled between a voltage source and the node; and
a third switch coupled between the node and the ground,
wherein the first switch, the second switch, and third switch can be independently, selectively opened and closed.

2. The power converter of claim 1, wherein the voltage of the voltage source is higher than the input voltage.

3. The power converter of claim 1, further comprising an isolation circuitry, the isolation circuitry comprising:
an inductor coupled between the node and the output voltage; and
a capacitor coupled between the output voltage and the ground.

4. The power converter of claim [0006], wherein, when the input voltage is lower than the output voltage, the third switch is set to open and the first switch and second switch are alternately and mutually exclusively set to open and close.

5. The power converter of claim [0006], wherein, when the input voltage is higher than the output voltage, the second switch is set to open and the first switch and third switch are alternately and mutually exclusively set to open and close.

6. The power converter of claim [0006] further comprising a switch controller coupled to the first switch, the second switch, and the third switch, wherein the switch controller selectively open and close the first switch, the second switch, and the third switch.

7. The power converter of claim 6, wherein the switch controller being capable of sensing the input voltage and the output voltage and selectively opening and closing the first, second, third switch according to the input voltage and the output voltage.

8. A power converter for generating an output voltage that is higher than an input voltage, the power converter comprising:
a node;
a first switch coupled between the input voltage and the node; and
a second switch coupled between a voltage source and the node,
wherein the first switch and second switch are alternately and mutually exclusively set to open and close.

9. The power converter of claim 8, wherein the voltage of the voltage source being higher than the input voltage.

10. The power converter of claim 8, further comprising an isolation circuitry, the isolation circuitry comprising:
an inductor coupled between the node and the output voltage; and
a capacitor coupled between the output voltage and the ground.

11. The power converter of claim 8, further comprising a switch controller coupled to the first switch and the second switch, the switch controller selectively open and close the first switch and the second switch.

12. A method for providing an output voltage higher or lower than an input voltage, comprising the steps for:
providing a first control signal to a first switch coupled between the input voltage and a node;
providing a second control signal to a second switch coupled between a voltage source and the node;
providing a third control signal to a third switch coupled between the node and the ground;
opening the third switch, and alternately and mutually exclusively opening and closing the first switch and second switch when the input voltage is lower than the output voltage; and
opening the second switch, and alternately and mutually exclusively opening and closing the first switch and third switch when the input voltage is higher than the output voltage.

13. The method of claim 12, wherein the voltage of the voltage source being higher than the input voltage.

14. The method of claim 12, further comprising the step for obtaining a direct output voltage by filtering a voltage generated at the node.

15. A method for producing an output voltage higher than an input voltage, comprising the steps for:
providing a first control signal to a first switch coupled between the input voltage and a node;
providing a second control signal to a second switch coupled between the voltage source and the node; and
alternately and mutually exclusively opening and closing the first switch and second switch.

16. The method of claim 18, wherein the voltage of the voltage source being higher than the input voltage.

17. The method of claim 18, further comprising the step for obtaining a direct output voltage by filtering a voltage generated at the node.
